(19) United States
(12) Patent Application Publication
(10) Pub. No.: US 2013/0295533 A1
(43) Pub. Date: Nov. 7, 2013

(54) Method and System for Educational Linking of Lyrical Phrases and Musical Structure

(71) Applicant: Jeremy David Spartz, Colorado Springs, CO (US)

(72) Inventor: Jeremy David Spartz, Colorado Springs, CO (US)

(73) Assignee: LYRICS2LEARN, LLC, Colorado Springs, CO (US)

(21) Appl. No.: 13/875,582

(22) Filed: May 2, 2013

Related U.S. Application Data
(60) Provisional application No. 61/642,109, filed on May 3, 2012.

(51) Int. Cl. G09B 5/06

(52) U.S. Cl. CPC G09B 5/06
USPC 434/156; 434/309

(57) ABSTRACT

An educational system and associated methodology links lyrical phrases with structural features of music creating educational tools for enhanced learning. According to one embodiment of the present invention, a system for enhanced learning includes lyrics customized to relay a lesson wherein the lyrics include one or more phrases of words. Structural features of music are tailored to function as an emotional stimulus while a visual display or rendering of the one or more phrases of words comprising the lyrics is presented to the user. The system further includes an audio presentation wherein a timing of the audibilization and visualization of the phrases that form the lyrics are synchronized with one or more structural features of music.

### RELATED APPLICATION

The present application relates to and claims the benefit of priority to U.S. Provisional Patent Application No. 61/642,109 filed 3 May 2012, which is hereby incorporated by reference in its entirety for all purposes as if fully set forth herein.

### BACKGROUND OF THE INVENTION

1. Field of the Invention

Embodiments of the present invention relate, in general, to learning methodology, and more particularly to methods and systems for learning that incorporate music into a lyrical lesson.

2. Relevant Background

There is a vast amount of research that has shown a deep connection between music and learning. For example, one author asserts that music relaxes the mind and lowers stress levels that may inhibit learning. When used effectively, music can increase alpha levels in the brain, boosting memory and recall and allowing the brain to access reserve capacities.

Music can also act directly on the body, specifically on metabolism and heartbeat. Listening to certain types of music can trigger the release of endorphins, producing a tranquil state that leads to faster learning.

It is additionally well known that music can stimulate and awaken, reviving bored or sleepy learners and increasing blood and oxygen flow to the brain. Music is a stage-changer and can be used effectively to get students into an effective learning state.

As music is mathematical, certain musical structures stimulate specialized brain pathways, allowing learners to decode complex ideas more easily. Moreover, it is a powerful anchor that moors learning in memory. Furthermore, music is a universal language, uniquely capable of crossing cultural barriers and training in ethnic traditions and values. It can set a dramatic stage for a variety of lessons, including lessons in history, foreign language, sociology, political studies, geography and the like. Lastly, music inspires emotion, creating a clear passage to both short-term and long-term memory.

Regarding the latter, while research has demonstrated that music conveys an emotion to its listener, it has also been shown that music can produce emotion in the listener. Studies have revealed observable responses to elicited emotions, thus reinforcing the notion that music does elicit real emotional responses.

The structural features of music not only help convey an emotional message, but also create an emotional state in the listener. These emotions can be completely new feelings or may be an extension of previous emotional events. Empirical research has shown that listeners can absorb the piece's expression as their own emotion. Additionally, music can invoke a unique response in the listener based on their personal experiences.

In studies on eliciting emotion, participants reported personally feeling a certain emotion in response to hearing a musical piece. Researchers have investigated whether the same structures that conveyed a particular emotion could elicit it, as well. Excerpts of fast tempo, major mode music and slow tempo, minor tone music were presented to participants; these musical structures were chosen because they are known to convey happiness and sadness, respectively. Participants rated their own emotions with elevated levels of happiness after listening to music with structures that convey happiness, and elevated sadness following music with structures that convey sadness. This evidence suggests that the same structures that convey emotions in music can also elicit those emotions in the listener.

Eliciting emotion in a student is well-known to be beneficial for learning. Stated simply, emotion leads to better retention of cognitive material. In the booked titled Cracking the Learning Code, J W Wilson states that neuroscientific research informs us that “emotions are not frivolous luxuries in which we indulge ourselves nor interlopers in the process of rational thought but instead are the primary organizing factors upon which consciousness, reason, and memory are built.” This author also suggests that “if information fails to elicit an emotional response, it will not be perceived as meaningful and therefore will have little chance of being selected into your memory.”

According to Priscilla Vail in her article titled The Role of Emotions in Learning, “Emotion is an on/off switch for learning . . . the emotional brain, termed the limbic system, has the power to open or close access to learning, memory, and the ability to make connections.” From a physiological stand point, emotions originate in the limbic system which is located between the brain stem and the cortex. The brain stem sends sensory messages through the limbic system to the cortex where thinking and learning occur. The entrance of this sensory information into the cortex is dependent on the limbic system's interpretation of this information as positive, negative or neutral. As indicated by Candy Lawson in The Connections between Emotions and Learning, this interpretation is dependent on one's past experience, memories, and immediate reaction to a current event. She summarizes the relationship between emotions and learning as follows: “Emotions and learning occur in the brain. Learning means acquiring knowledge or skills. Learning requires thinking Our thoughts influence how we feel. How we feel influences how we think.”

Thus, it is clear that both emotion and music can enhance learning. While these tools have been exploited independently to benefit the learning process, there remains an unmet need for methods and systems that effectively harness music and emotion together to increase fluency and comprehension of a lesson. This and other deficiencies of the prior art are addressed by one or more embodiments of the present invention.

### SUMMARY OF THE INVENTION

Presented hereafter by way of example is a system and associated methodology linking lyrical phrases with structural features of music creating educational tools for enhanced learning. According to one embodiment of the present invention, a system for enhanced learning includes lyrics customized to relay a lesson composed of one or more phrases of words. The system further includes one or more structural features of music tailored to function as an emotional stimulus and a visual display or rendering of the one or more phrases of words comprising the lyrics. The lyrics are linked to an audio presentation wherein a timing of the audibilization and visualization of the words in the phrases that form the lyrics are synchronized with one or more structural features of music so as to elicit an emotional response.

Another aspect of the present invention includes a method for educational fluency and comprehension training using recursion of linguistically similar phrases. Such a process begins by linking a musical structure to a particular educational lesson. In such an instance, the musical structure includes a metric level and a tempo consistent with linguistically similar phrases. The process further correlates a portion of the linguistically similar phrases of the educational lesson with a visual cue based on the musical structure. In one embodiment of the present invention, the visual cues can include highlighting a particular selection of words (a phrase) contemporaneously with their audibilization. In such a manner, a student hears the words while seeing the phase while both of which are associated with particular structures of music.

The process of enhanced learning using lyrical phrases with structural features of music is augmented by introducing a particular lesson to a student repetitively. According to one embodiment of the present invention, a student listens to the audibilization of a set of words accompanied by various musical structures while seeing a visual rendering of the phrases associated with the set of words repetitively. That is, the student listens to the entire lesson a plurality of times. The student then is asked a series of questions to reinforce the learning, fluency and comprehension process. Lastly, this sequence of events repeats, in one embodiment, three times. The combination of music, audibilization and visual stimuli enhance the student's ability to gain fluency in the words and comprehension of the lesson.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows an exemplary set of lyrics customized to relay a lesson according to one embodiment of the present invention;

FIG. 2 illustrates a musical composition associated with the lesson depicted in FIG. 1, according to one embodiment of the present invention;

FIG. 3 presents an exemplary set of questions associated with the lesson depicted in FIG. 1 designed to evaluate a user's comprehension of the lesson relayed by lyrics in accordance with one embodiment of the present invention;

FIG. 4 is a depiction of a flow diagram of one methodology for enhanced learning that illustrates an implementation of a sequence of events by a student in accordance with the present invention;

FIG. 5 is a graphical representation of the change in words per minute by 22 individual students after an 8 week exposure to one embodiment of the present invention;

FIG. 6 is a bar graph portraying a comparison between the change in words per minute by 22 individual students after an 8 week exposure to one embodiment of the present invention and the change in words per minute by the same 22 students after undertaking 21 weeks of a traditional learning system; and

FIG. 7 contrasts the difference between the mean change in words per minute of 22 students after an 8 week exposure to one embodiment of the present invention and the mean change in words per minute by the same 22 students after undertaking 21 weeks of a traditional learning system.

The Figures depict embodiments of the present invention for purposes of illustration only. The Figures depict embodiments of the present invention for purposes of illustration only.

### DESCRIPTION OF THE INVENTION

The present invention includes the novel incorporation of music and visual renderings into a lyrical lesson. In one embodiment of the present innovation, lyrics that relay a lesson are associated with specific structural elements of music that elicit emotion. When the lyrics and music are synced, according to one embodiment of the present invention, an audio presentation is created. The audio presentation is synced with a visual presentation of specific portions of the lyrics to produce an audio and visual presentation. The resultant audio and visual presentation functions to improve fluency, enhance comprehension and develop background knowledge of the associated lesson. This and other applications of a method and system for incorporating music into a lyrical lesson are possible and contemplated by one or more embodiments of the present invention.

Embodiments of the present invention are hereafter described in detail with reference to the accompanying figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying figures is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purposes only and not for the purpose of limiting the invention as defined by the appended claims and their equivalents.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

The terminology used herein is for the purpose of describing particular embodiments only and is not intended to be limiting of the invention. As used herein, the singular forms “a,” “an,” and “the” are intended to include the plural forms as well, unless the context clearly indicates otherwise.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

One or more embodiments of the present invention address the challenges of finding effective strategies to teach students. In particular, the challenges associated with instructing reading fluency and comprehension have been especially problematic.

Fluency refers to a student's speed, smoothness, and ease of reading. Fluent readers read more quickly and smoothly, allowing them to focus on comprehension. Fluent readers gain more meaning from the text they read. Because fluency leads to comprehension, fluent readers enjoy reading more than students who devote all their energy to sounding out words. It is an object of the implementation of one or more embodiments of the present innovation to improve a student's reading fluency.

One of reasonable skill in the relevant art will appreciate that reading comprehension is understood to be the level of understanding of text. This understanding comes from the interaction between the words that are written and how they trigger knowledge outside of the text. Proficient reading depends on the ability to recognize words quickly and effortlessly. If word recognition is difficult, students use too much of their processing capacity to read individual words, which interferes with their ability to comprehend what is read. An aim of the implementation of one or more embodiments of the present invention is to enhance a student's capacity to comprehend reading.

Traditionally, reading has been taught using phonics. The goal of the phonics method is to enable readers to decode new written words by sounding them out, or in phonics terms, blending the sound-spelling patterns. Synthetic phonics involves examining every letter within the word as an individual sound in the order in which they appear and then blending these sounds together. For example, shrouds would be read by pronouncing the sounds for each spelling “/ [symbol] , r, a [symbol] , d, z/” and then blending these sounds orally to produce a spoken word, “/ [symbol] ra [symbol] dz/.” The goal of phonics instruction is for students to identify the sound-symbol correspondences and blend their speech sounds (phonemes) automatically. Since this approach focuses on the spoken and written units within words, phonics employs a sublexical methodology.

In practice, a solely phonics-based approach to teach a language has been problematic. English spelling, for example, is based on the alphabetic principle. In an alphabetic writing system, letters are used to represent speech sounds, or phonemes. For example, the word “pat” is spelled with three letters, p, a, and t, each representing a phoneme, respectively, /p/, /æ/, and /t/. The spelling structures for some alphabetic languages, such as Spanish, are comparatively simple (orthographically shallow), because there is nearly a one-to-one correspondence between sounds and the letter patterns that represent them. However, English spelling is more complex (orthographically deep), partly because English attempts to represent the 40+ phonemes of the spoken language with an alphabet composed of only 26 letters. As a result, two letters are often used together to represent distinct sounds. For example t and h placed side by side represent either /θ/ or / [symbol] /.

Compounding the complexity of English spelling patterns is the reality that English has absorbed many words from other languages throughout its history, usually without changing the spelling of those words. As a result, the written form of English includes the spelling patterns of many languages superimposed upon one another. These overlapping spelling patterns mean that, in many cases, the same sound can be spelled differently and the same spelling can represent different sounds. The result is that English spelling patterns vary considerably in the degree to which they follow rules. For example, the letters ee almost always represent /i:/, but the sound can also be represented by the letters i and y. Similarly, the letter cluster ough represents / [symbol] f/ as in enough, /o [symbol] / as in though, /u:/ as in through, / [symbol] f/ as in cough, /a [symbol] / as in bough, / [symbol] / as in bought, and / [symbol] p/ as in hiccough, while in slough and lough, the pronunciation varies.

As English spelling patterns are often inconsistent, students taught using phonics have a tendency to struggle with fluency. This, in turn, leads to difficulty with comprehension because their brain has been “trained” to focus on individual sounds and words. Consequently, their reading is choppy and fragmented, making any level of comprehension much more challenging.

In contrast to phonics is the whole language approach, which is a word-level-up philosophy for teaching reading. According to such a teaching methodology, a student can learn to recognize several words as easily as letters. Therefore, rather than feed words to the student letter by letter, a teacher can provide him or her with the complete word so the student can focus immediately on the meaning. Within a whole language perspective, language is treated as a complete meaning-making system, the parts of which function in relational ways.

Whereas phonics employs a sublexical methodology, the whole language approach comprises lexical reading, which involves acquiring words or phrases without attention to the characters or groups of characters that compose them. The idea of “whole” language has its basis in a range of theories of learning related to the epistemologies called “holism.” Holism is based upon the belief that it is not possible to understand learning of any kind by analyzing small chunks of the learning system.

One embodiment of the present invention employs a whole language approach to help students train their brain to see and say words as phrases with meaning, rather than processing individual words or letters that must be strung together to become meaningful. By incorporating this methodology into the novel system for education described herein, the present invention engages a student in the learning process by providing him or her with a new, upbeat and entertaining way to learn how to read and comprehend information.

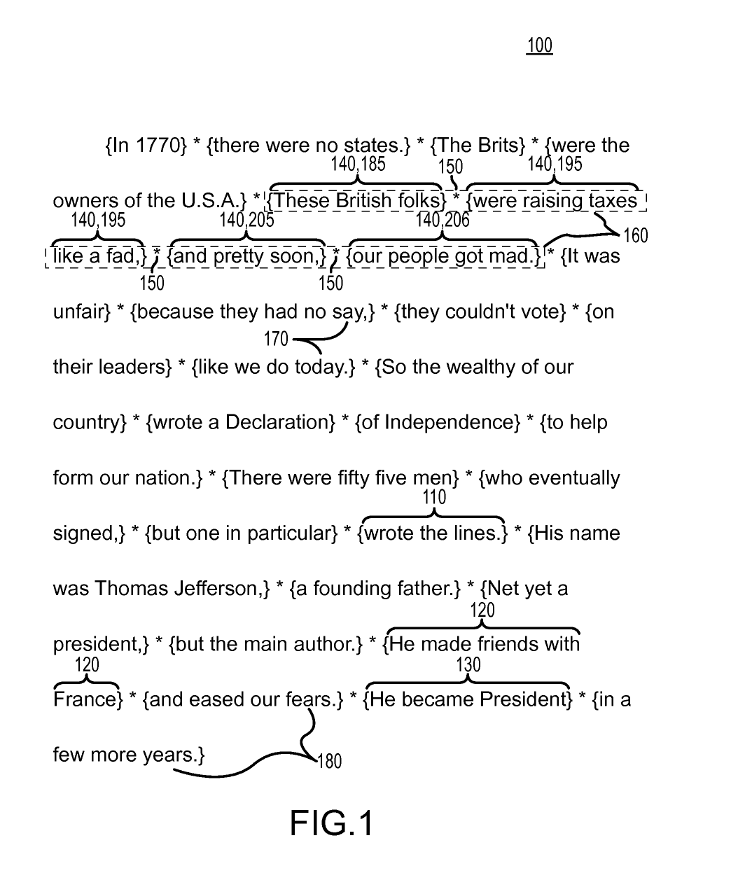

Towards this effort, the present innovation employs lyrics that are customized to relay a lesson. The term “lyrics” refers herein to a composition of words written in metrical feet forming rhythmical lines. The lesson can encompass any subject matter, including but not limited to mathematics, science, geography, social studies, history, humanities and the like. Take as an example of one embodiment of the present invention, a history lesson about Thomas Jefferson, the 3^{rd} president of the United States. After selecting a topic for the lesson, the words that comprise the lyrics are specifically chosen such that they function together globally to teach a lesson regarding the elected topic. In an example of one embodiment of the present innovation on the subject of Thomas Jefferson, the lyrics 100, shown in FIG. 1, are composed to teach a lesson about the 3rd President of the United States. This lesson includes his role as principal author of the Declaration of Independence 110, his role as the United States Minister to France 120 and his election to presidency 130.

In addition to the words of the lyrics functioning globally to teach a lesson, the words also function together locally in phrases 140 that are bound by natural pauses in speech 150. As an example of one embodiment of the present invention, these phrases 140 are distinguished by curly brackets ({ }), and natural pauses in speech 150 are denoted by asterisks (*) within the lyrics illustrated in FIG. 1. For example, the third sentence 160 of the lesson is divided into four phrases 140. When this sentence 160 is spoken aloud naturally, each of the four phrases 140 is read with a natural pause 150 both before the phrase and after the phrase. In this way, each phrase within the lyrics 100 is bound by a natural pause in speech. Within the lyrics 100 composed to teach a lesson about Thomas Jefferson, there are 29 phrases and 28 pauses.

Natural pauses in speech are significant because they come between groups of words that express one thought. These pauses are essential to comprehension, as they help the speaker and the listener organize the information correctly. For further clarification, note the following example using this sentence: The dog goes for a walk in the morning, plays with a ball in the afternoon, and chews on a bone in the evening. When naturally spoken, the sentence can have the following pauses in speech: The dog goes for a walk in the morning (pause) plays with a ball in the afternoon (pause) and chews on a bone in the evening. By incorporating these specific pauses into the sentence when speaking, the speaker and listener can easily organize and comprehend the three activities of the dog. However, when pauses are employed incorrectly, comprehension is much more challenging. For example, the exemplary sentence with improper pauses can be as follows: The dog goes (pause) for a walk in (pause) the morning plays with a ball in (pause) the afternoon and chews on (pause) a bone in the evening. In this instance with improper pausing, the dog's three activities are nearly impossible to understand.

One embodiment of the present invention acknowledges the importance of pauses within speech for the comprehension of thoughts expressed by groups of words and incorporates this concept as phrases (groups of one or more words) bound by natural pauses in speech within the lyrics wherein one phrase expresses one thought. By properly dividing the lyrics into a plurality of phrases, a whole language approach is undertaken to help a student train his or her brain to see and say words as phrases with meaning.

Also, according to one embodiment of the present invention, two or more of the words comprising the lyrics function individually to rhyme. A rhyme is one of two or more words that correspond in sound. The ability to recognize and produce rhyming words is an important phonological awareness skill. Indeed, research indicates that there is a correlation between phonological awareness and reading ability. For this and other reasons, rhyming is incorporated into one of more embodiments of the present innovation. In FIG. 1, one exemplary set of rhymes 170 includes the words “say and today,” and another exemplary set of rhymes 180 is comprised of the words fears and years.

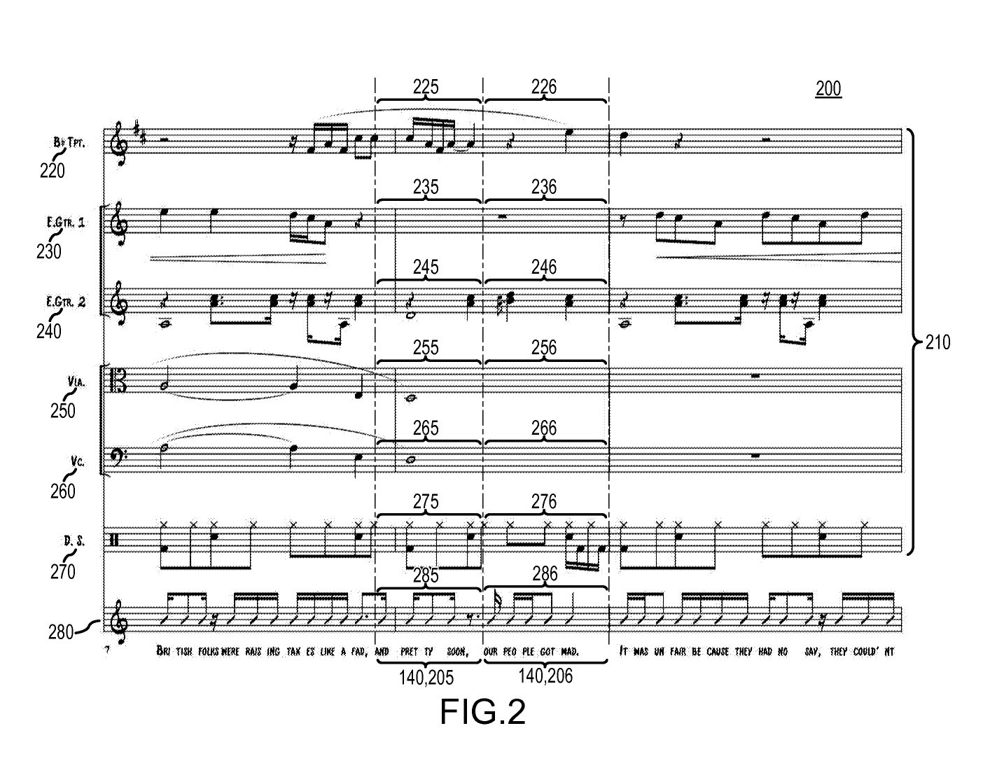

After lyrics have been tailored to convey a lesson as described above, a musical composition 200, in accordance with one embodiment of the present invention, is selected to accompany these lyrics 100 as illustrated in FIG. 2. In this figure, an instrumental blues rock musical score 210 is presented for a trumpet 220, electric guitar one 230, electric guitar two 240, a viola 250, a cello 260 and a drum set 270. In addition, the musical notes for the audibilization of the lyrics 280 are shown in sync with the blues rock musical score 210. As an example, the phrase “and pretty soon” 140, 205 from sentence three 160 of the lyrics 100 is musically audibilized 285 contemporaneously with the playing of the accompanying notes specific to the trumpet 225, electric guitar one 235, electric guitar two 245, the viola 255, the cello 265 and the drum set 275. Following, the phrase “our people got mad” 140, 206 from sentence three 160 of the lyrics 100 is musically audibilized 286 contemporaneously with the playing of the accompanying notes specific to the trumpet 226, electric guitar one 236, electric guitar two 246, the viola 256, the cello 266 and the drum set 276. In this manner, the audibilization of the lyrics 100, 280 are set to instrumental music 210 in one embodiment of the present innovation.

The musical composition is comprised of one or more specific musical structures chosen to act as an emotional stimulus in accordance with one embodiment of the present invention. Structural features of music are categorized as segmental features and suprasegmental features. The former features are the individual sounds or tones that make up the music and include, but are not limited to, acoustic structures such as duration, amplitude and pitch. The latter musical structures are the systematic configurational changes in sound sequences over time, including but not limited to such features as melody, tempo, rhythm and harmony.

While it has long been recognized that music both conveys and elicits emotion, the exact emotion created is quite subjective. Nevertheless, there are a number of specific musical features that are highly associated with particular emotions. Examples of these relationships include, but are not limited to: a fast tempo generates happiness or excitement whereas a slow tempo gives rise to sadness or serenity. Also, major tonality often conveys happiness or joy, while minor tonality is associated with sadness. Moreover, loudness, or the physical strength and amplitude of a sound, may be perceived as intensity, power, or anger; soft music is suggestive of tenderness, sadness, or fear. Rapid changes in loudness may connote playfulness or pleading, whereas few or no changes can indicate peace and sadness. Furthermore, regarding melody, a wide range of notes can imply joy, whimsicality, or uneasiness whereas a narrow range suggests tranquility, sadness, or triumph. In addition, consonant, or complementing harmonies, are connected with feelings of happiness, relaxation, or serenity; dissonant, or clashing harmonies, imply excitement, anger, or unpleasantness. Lastly, a smooth, consistent rhythm is associated with happiness and peace, while a rough, irregular rhythm is associated with amusement and uneasiness. A varied rhythm implies joy.

By selecting a composition comprised of one or more structural features of music and precisely pairing the feature(s) with specific lyrics 100 and, in one embodiment of the present invention, further matching the feature(s) with particular phrases 150 within the lyrics 100, one or more emotions are stimulated in the student. Thus, the lesson (a specific combination of lyrics and music) elicits an emotional response and, consequently, it will likely be perceived as meaningful; as a result, the lesson has an improved chance of being incorporated into the student's memory. For this purpose, the present invention utilizes musical compositions from many genres including, but not limited to, blues, country, hip hop, jazz, pop and rock.

Another feature of the present invention includes the audibilization of the lyrics synchronized with the playing of accompanying music. When the lyrics 100 are audibilized in sync with the music, an audio presentation corresponding to an explicit lesson is produced. According to one embodiment of the present invention, the words of the lyrics are spoken by a speaker in phrases bound by natural pauses in speech. In another embodiment of the present invention, the words of the lyrics are sung by a singer. The implementation of one embodiment of the present innovation includes directing a student to listen to the audio presentation, that is, the audibilization of the lyrics combined with a visual rendering.

In conjunction with an audio presentation, one embodiment of the present innovation also includes a visual presentation compatible with the lesson. This visual presentation is created by displaying the words that comprise the lyrics. According to one embodiment of the present invention, the lyrics are displayed with the phrases visually highlighted in sync with the audibilization of the corresponding phrases accompanied by music. Thus, the learning exercise includes both an audio and visual presentation. To implement one embodiment of the present invention, a student is directed to listen to the audio presentation while watching the visual presentation. To further clarify this concept with further reference to FIG. 1, when sentence three 160 within the lyrics 100 is spoken by a speaker in phrases 140 bound by natural pauses 150 in speech, the timing of the speaking of the phrase “These British folks” 185 and the playing of the accompanying music is in sync with exclusive visual highlighting of the phrase “These British folks” 185. Following, the next phrase “were raising taxes like a fad” 195 is spoken with musical accompaniment and simultaneously, the phrase “were raising taxes like a fad” 195 is exclusively highlighted in the visual display. Note that the entire phrase is simultaneously highlighted rather than the individual words as they are audibilized. In this manner, the entire lyrical lesson is audibly and visually presented to a student, with both an audio and visual emphasis on the individual phrases 140 within the lyrics 100. In accordance with another embodiment of the present invention, both the lyrics and one or more graphics are visually displayed.

In addition to directing a student to both listen to the audio presentation and watch the visual presentation, one embodiment of the present invention also requests that the student vocalize the words of the lyrics in sync with the audio and visual presentations.

Another feature of the present invention is repetitive learning. As eloquently stated by Saint Thomas Aquinas, “Repetition is the mother of all learning.” Confirmed by research, repetition is of vital importance to the learning process. In one embodiment of the present invention, a student is repeatedly exposed to the learning exercise, which, in this embodiment, is comprised of one audio and visual presentation played and displayed from the beginning of the lyrics to the end of the lyrics. From the student's perspective, according to one embodiment of the present invention, he or she listens to the audio presentation while watching the synced visual presentation at least two or more times.

As an example of the implementation of one embodiment of the present invention, a student is directed to listen to an audio presentation of the lyrical lesson 100 while simultaneously watching the visual presentation and vocalizing the lyrics for a first time. The length of this first exposure to the lesson is approximately, but not limited to, two to three minutes. At this point, the student has entertained the lesson one time. After the first presentation has ended, the student immediately repeats the process of listening to the same audio presentation of the lyrical lesson 100 while simultaneously watching the same visual presentation and vocalizing the lyrics for a second time, again taking approximately, but not limited to, two to three minutes. Now, the student has repeated the lesson once, having undertaken the audio and visual presentation twice. Immediately after the second presentation's conclusion, the student again repeats the process of listening to the same audio presentation of the lyrical lesson 100 while simultaneously watching the same visual presentation and vocalizing the lyrics for a third time, again taking approximately, but not limited to, two to three minutes. Following the third presentation, the student has repeated the lesson twice, having been directed to listen to and watch the audio and visual presentation three times. In total, this entire process of repeating the lesson takes roughly, but not limited to, 10-15 minutes and comprises what is herein termed a program, according to one embodiment of the present innovation.

Following a student's repeated exposure to the exercise, the system for educating and enhanced learning, according to one embodiment of the present invention, provides means for evaluating the student's comprehension of the lesson. After listening to and watching the lesson a plurality of times, the student is presented with questions which assess understanding of the lesson's educational content that has been incorporated into the student's short-term memory. The forms of assessment can vary and include, but are not limited to, multiple choice questions, true or false questions and fill-in-the-blank questions. In another embodiment of the present invention, the essence of the questions is in accordance with the common Core Curriculum Standards adopted by 36 states and exemplified by Depth of Knowledge Levels.

In accordance with yet another embodiment of the present invention, a student is directed to undertake a program multiple times wherein each program is comprised of repeated exposure to an audio and visual presentation of a lesson. As in the example depicted above, the program includes listening to the audio presentation and simultaneously watching the visual presentation and vocalizing the lyrics three times, taking a total of, but not limited to, 10-15 minutes. After this first exposure to the program, the student becomes familiar with the lesson. Following a predetermined period of time (for example, one day), the student undertakes the entire program again, for a second time, which includes listening to the audio presentation and simultaneously watching the visual presentation and vocalizing the lyrics three times, taking a total of, but not limited to, 10-15 minutes. After this second exposure to the program, the student becomes more familiar with the lesson than they were after only one exposure to the program. Following a predetermined period of time (for example, one day), the student undertakes the entire program again, for a third time, which includes listening to the audio presentation and simultaneously watching the visual presentation and vocalizing the lyrics three times, taking a total of, but not limited to, 10-15 minutes. After this third exposure to the program, the student becomes even more familiar with the lesson than they were after only being exposed to the program twice. It is in this way, according to one embodiment of the present invention, that the student gains familiarity with the lesson.

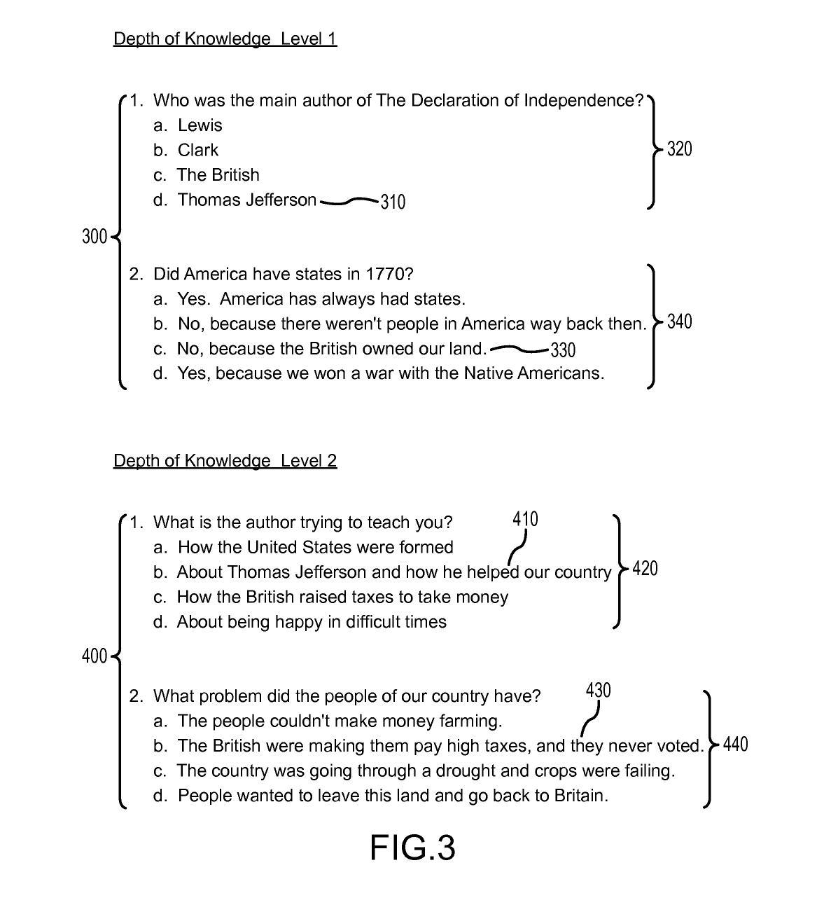

In accordance with one embodiment of the present innovation, the questions designed to assess understanding of the lesson's educational content increase in comprehension complexity as the student becomes more familiar with the program and associated lesson. An exemplary embodiment of questions contemplated by the present invention that conform to the common Core Curriculum Standards and increase in Depth of Knowledge Level are detailed in FIG. 3. These particular questions pertain to the lyrics 100 regarding the lesson about Thomas Jefferson. After a student is initially familiarized with the lesson following a first program, Depth of Knowledge Level One questions 300 are presented that involve recall and reproduction from the text. The answer 310 to question one 320 can be found directly in phrases 22-25 of the lyrics 100 shown in FIG. 1. Likewise, the answer 330 to question two 340 is located within phrases 1-4 of the lyrics 100 shown in FIG. 1. Thus, the answers 310, 330 to Depth of Knowledge Level One question 300 require a student to only recall and reproduce information directly from the text. After a student becomes more familiar with the lesson subsequent to a second program, Depth of Knowledge Level Two questions 400 are offered that concern skills, concepts and basic reasoning. The answer 410 to question one 420 and the answer 430 to question two 440 cannot be found verbatim in the text, in contrast to Depth of Knowledge Level One questions 300. Instead, correctly deducing the answers to Depth of Knowledge Level Two questions 400 obliges a student to employ basic reasoning, which is an increase in comprehension complexity from recall and reproduction of the text. In this fashion, as a student becomes more familiar with the program and the associated lesson, the assessment of his or her level of understanding is increased.

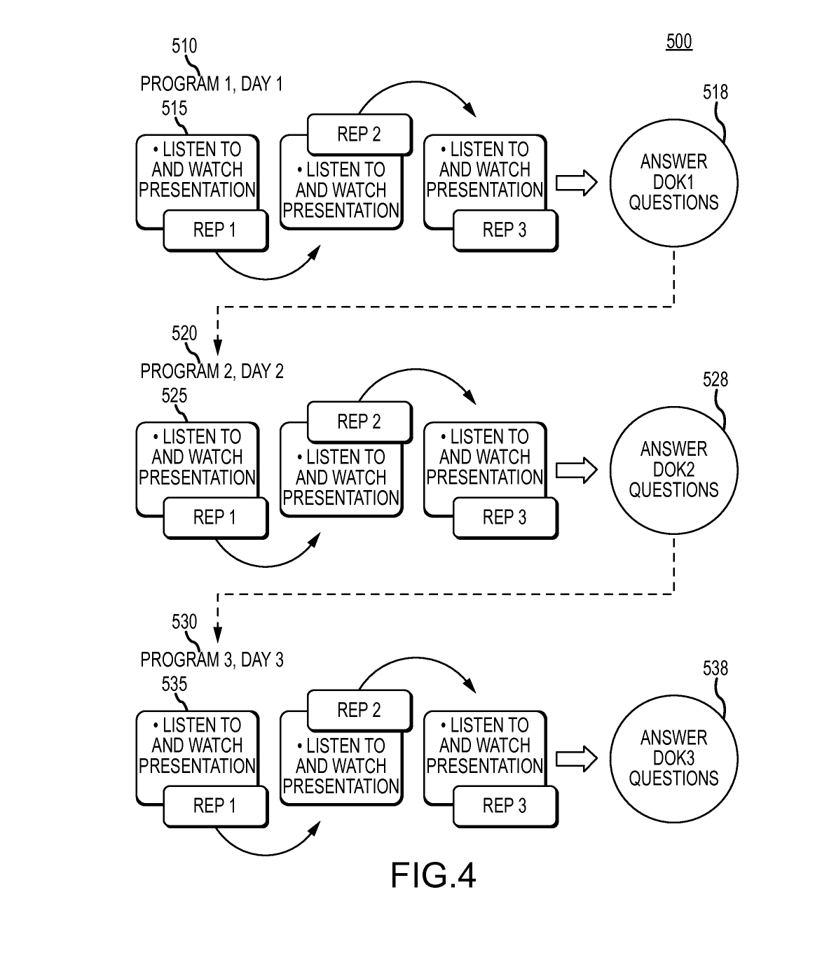

To better understand the implementation of one or more embodiments of the present invention, the following example, corresponding to FIG. 4, is given wherein the education system 500 comprises three programs 510, 520, 530. The programs 510, 520, 530 are administered in succession over a predetermined course of time. For example, Program 1 510 is given on Day 1, Program 2 520 is given on Day 2 and Program 3 530 is given on Day 3. Within each program, there is an exercise 515, 525, 535 that is repeatedly performed by the student. As an example, the student listens to the audio presentation while watching the synced visual presentation three times. Upon completion, the student is then presented with questions 518, 528, 538 to assess comprehension of the lesson taught by the lyrics incorporated into the exercise 515, 525, 535. On Day 1, the questions 518 are derived from Depth of Knowledge Level One (DOK1) concepts, involving recall and reproduction. On Day 2, the questions 528 are derived from Depth of Knowledge Level Two (DOK2) ideas, concerning skills, concepts and basic reasoning. And, on Day 3, the questions 538 are derived from Depth of Knowledge Level Three (DOK3) notions, focusing on strategic thinking and complex reasoning.

In accordance with the embodiment of the present invention detailed above, Program 1 510 functions to familiarize the student with the lyrics, including both the corresponding lyrical words and the direct lesson the lyrics relay. While engaging in Program 2 520, the student concentrates less on the words and more on the meaning of the phrases of words as he or she becomes accustomed to the pace and vocabulary. As the student takes on Program 3 530, he or she has likely memorized the lesson's lyrics. Consequently, the student begins to connect to and think differently about the lyrics and the lesson they convey. The corresponding DOK3 questions address these higher-order thinking skills.

According to yet another embodiment of the present invention, an additional program is presented that functions as an extension for students capable of being further challenged with advanced thinking and reasoning. This fourth program includes writing, research, or high level connections between themes, impacting ideas, or comparing and contrasting such notions and how they affect various aspects of personal and community living.

In yet another embodiment of the present innovation, the system for educating is expanded to include multiple lessons presented to a student over a span of time. For example, six lessons are provided over six weeks. In a single week, a lesson is taught by Programs 1 510, 2 520 and 3 530 as detailed above. Each week, the composition of the lesson is different; in other words, each week has a unique audio and visual presentation. According to one embodiment of the present invention, the rate that the words of the lyrics are audibilized, termed words per minute, increases each week with each lesson. Words per minute, abbreviated WPM, is a common metric for assessing reading speed and is often used in the context of remedial skills evaluation.

To better understand the concept of increasing words per minute with successive lessons, consider the following example implementing one embodiment of the present innovation. Lesson one's subject matter regards the Coliseum in Rome and is audibilized at a rate of 125 WPM; lesson two concerns Niagara Falls and is audibilized at a rate of 145 WPM; lesson three is about the Amazon Rain Forest and is audibilized at a rate of 150 WPM; lesson four is in relation to the Great Wall of China and is audibilized at a rate of 155 WPM; lesson five's topic is the Great Barrier Reef and is audibilized at a rate of 165 WPM; and lastly, lesson six is on the subject of Egypt and the Pyramids and is audibilized at a rate of 170 WPM.

In addition to increasing the rate that the words of the lyrics are audibilized, the number of syllables within the phrases also increase in successive lessons, according to one embodiment of the present innovation. One feature of the present invention syntactically controls syllabication length of linguistically similar phrases comprising the lesson. Moreover, the tempo of the music, which is matched to the formation of the phrases, increases as the words per minute and number of syllables increase in succeeding lessons.

Following the six lessons, in accordance with one embodiment of the present invention, the student is then supplied with one or more review exercises that pertain to the prior lessons. These one or more review lessons function to reintroduce the preceding lessons and compel the student's brain to recall previously learned information from his or her long-term memory, which reinforces the fluency and comprehension of the lessons.

The present innovation can benefit any student in any educational setting, including, but not limited to, the classroom and the home. In accordance with one embodiment of the present invention, the system is web-based and can be independently undertaken by either an individual student or groups of students.

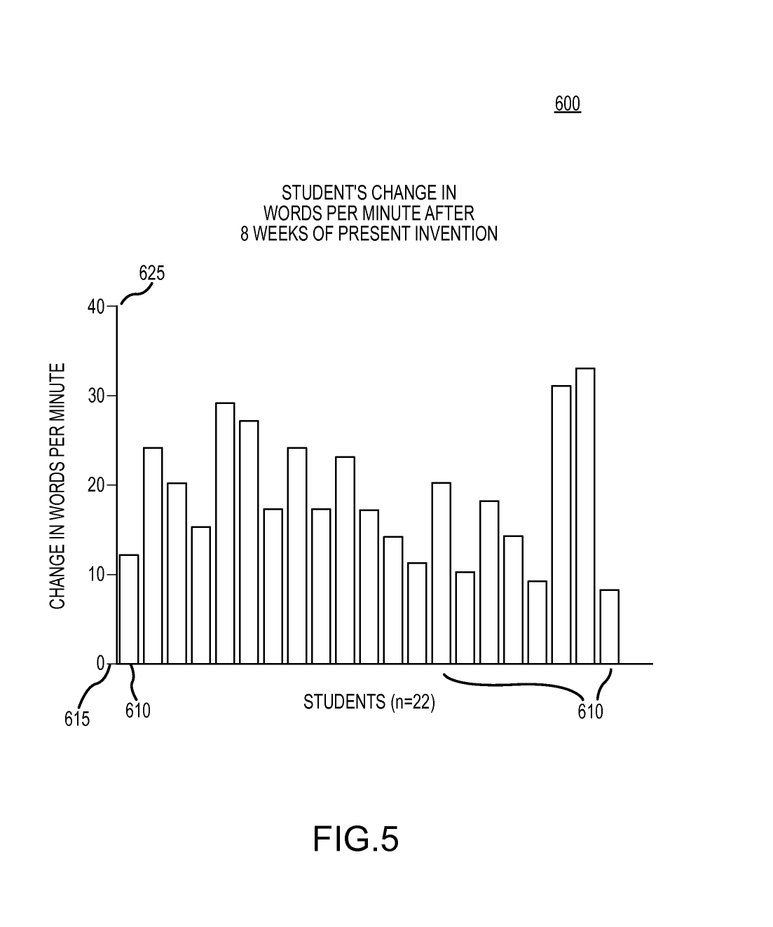

In summary, one embodiment of the present invention provides a method and system for education that compels a student to listen, look at, and vocalize lyrics that convey a lesson and are in sync with music. This provokes, among other things, interest, excitement, and emotion in the student; consequently, fluency, comprehension, and background knowledge development of the associated lesson are enhanced. Data indicates that this method and system is more efficient, effective, and productive than other methods of whole language reading instruction. FIG. 5 depicts the change in words per minute (as measured by DIBELS Oral Reading Fluency, which is a standardized, individually administered test of accuracy and fluency with connected text) in 22 students that were taught using the method and system detailed by an exemplary embodiment of the present invention.

To further elaborate on FIG. 5, this bar graph 600 represents each student as a bar 610 on the x axis 615. On the y axis 625, the particular student's change in words per minute after eight weeks of exposure to one embodiment of the present innovation is depicted by the height of that student's bar 610. The higher a student's bar 610, the greater the student's increase in words per minute.

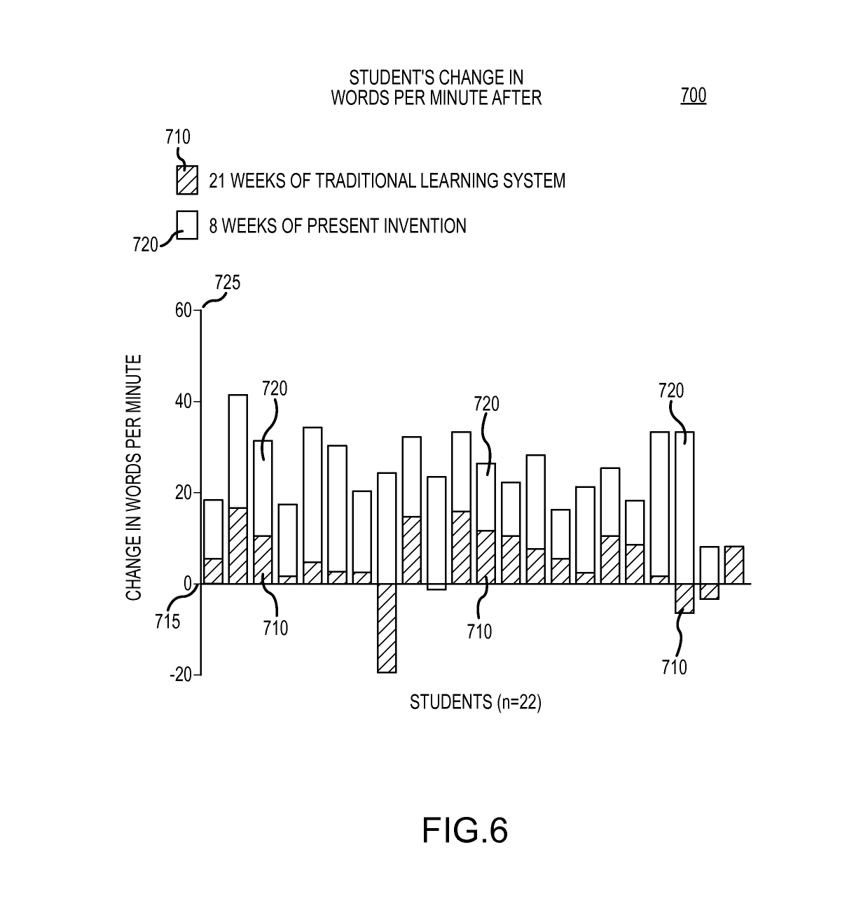

Prior to this experiment, the same students were taught using a traditional learning system for 21 weeks. A comparison of the individual's change in words per minutes (as measured by DIBELS Oral Reading Fluency), using both systems is illustrated in FIG. 6. In this bar graph 700, each student is represented by two bars 710,720 on the x axis 715. On the y axis 725, the particular student's change in words per minute after 21 weeks of exposure to a traditional learning system for reading is shown by the height of that student's white bar 710 originating at the x axis 715. In addition, the particular student's change in words per minute after eight weeks of exposure to one embodiment of the present invention is illustrated by the height of that student's black bar 720 originating at the x axis 715. In the case of all 22 students, the change in their words per minute was greater after an 8-week exposure to one embodiment of the present innovation than after undertaking 21 weeks of a traditional learning system.

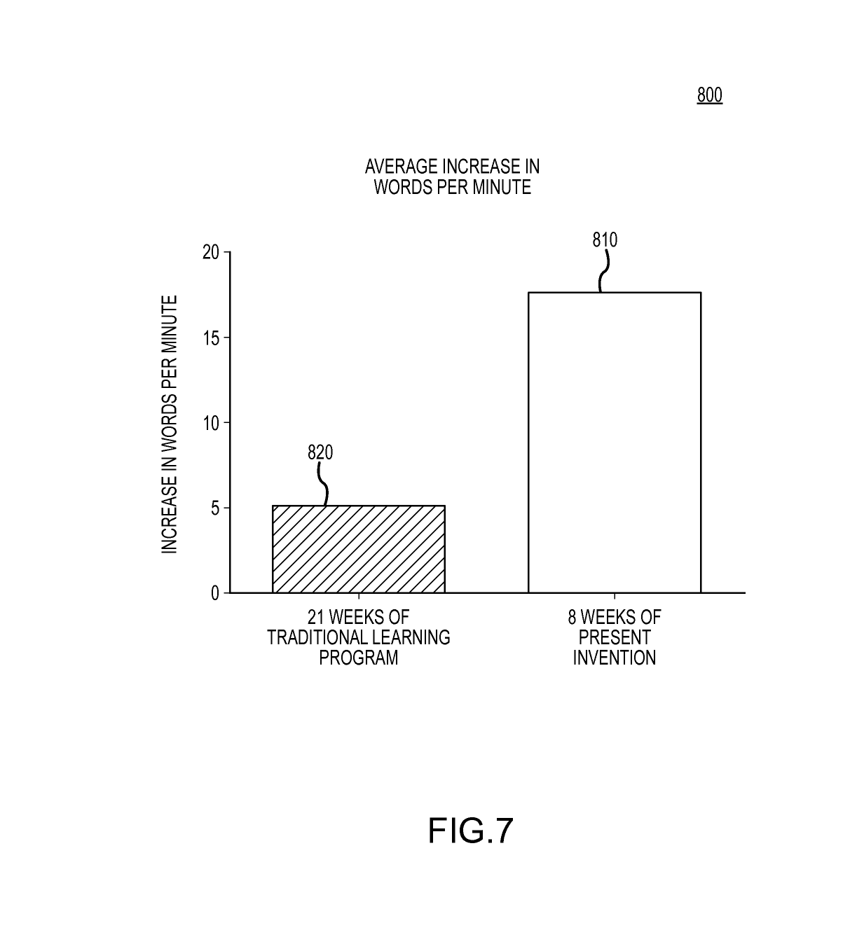

As depicted by the bar graph 800 in FIG. 7, when the traditional learning system was employed, the average increase was only 5 words per minute after 21 weeks of instruction (exemplified by the white bar 810). However, when students were taught with an exemplary embodiment of the present invention, after only 8 weeks, the average increase was an impressive 18 words per minute (represented by the black bar 820).

The terms and words used in the following description and claims are not limited to the bibliographical meanings, but, are merely used by the inventor to enable a clear and consistent understanding of the invention. Accordingly, it should be apparent to one of reasonable skill in the relevant art that the following description of exemplary embodiments of the present invention are provided for illustration purposes only and not for the purpose of limiting the invention.

While there have been described above the principles of the present invention in conjunction with a method to enhance learning through the use of music, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. It should be understood that the scope of the disclosure herein also includes any novel feature or any novel combination of features disclosed either explicitly or implicitly or any generalization or modification thereof which would be apparent to persons skilled in the relevant art, whether or not such relates to the same invention as may be claimed in the future and whether or not it mitigates any or all of the same technical problems as confronted by the present invention. The Applicant hereby reserves the right to formulate claims to such features and/or combinations of such features during the prosecution of the present application or of any further application derived therefrom.

While the invention has been particularly shown and described with reference to embodiments, it will be understood by those skilled in the art that various other changes in the form and details may be made without departing from the spirit and scope of the invention.

While there have been described above the principles of the present invention in conjunction with examples, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. It should be understood that the scope of the disclosure herein also includes any novel feature or any novel combination of features disclosed either explicitly or implicitly or any generalization or modification thereof which would be apparent to persons skilled in the relevant art, whether or not such relates to the same invention as claimed in any claim and whether or not it mitigates any or all of the same technical problems as confronted by the present invention. The Applicant hereby reserves the right to formulate claims to such features and/or combinations of such features during the prosecution of the present application or of any further application derived therefrom.

I claim:

1. A system for educating comprising:
lyrics customized to relay a lesson wherein the lyrics include one or more phrases of words;
one or more structural features of music tailored to function as an emotional stimulus;
a visual display of the one or more phrases of words comprising the lyrics;
an audio presentation wherein an audibilization timing of the one or more phrases of words is synchronized with an audio production timing of the one or more structural features of music; and
a visual presentation wherein an audio presentation timing is synchronized with a visual display timing of the one or more phrases of words comprising the lyrics.

2. A system for educating according to claim 1, wherein the audibilization of the one or more phrases of words comprising the lyrics is accomplished by speaking the one or more phrases of words comprising the lyrics bound by predetermined pauses in speech.

3. A system for educating according to claim 1, further comprising a synchronization timing of visual highlighting wherein one or more phrases of words within the visual display are highlighted synchronously with the audio presentation timing and the visual presentation timing.

4. A system for educating according to claim 1, wherein the audibilization timing of the one or more phrases of words corresponds to a predetermined rate of words per minute.

5. A system for educating according to claim 1, wherein the audio production timing of the one or more structural features of music corresponds to a predetermined rate of beats per minute.

6. A system for educating according to claim 1, wherein the audibilization timing of the one or more phrases of words corresponds to a predetermined rate of words per minute and the audio production timing of the one or more structural features of music corresponds to a predetermined rate of beats per minute.

7. A system for educating according to claim 1 wherein the structural features of music are segmental features.

8. A system for educating according to claim 1 wherein the structural features of music are suprasegmental features.

9. A system for educating according to claim 1, further comprising instruction for a student to vocalize the one or more phrases of words comprising the lyrics in concordance with the audio presentation and the visual presentation.

10. A system for educating according to claim 1, further comprising an administration of the audio and visual presentation two or more times within a predetermined period of time.

11. A system for educating according to claim 1, further comprising means for evaluating a student's comprehension of the lesson.

12. A system for educating according to claim 1, further comprising means for evaluating a student's comprehension of the lesson wherein student comprehension of the lesson is evaluated by providing a set of questions that relate to the lesson and wherein the set of questions increase in comprehension complexity with successive lessons.

13. A method for educational fluency and comprehension training, comprising:
forming an educational lesson using recursion of linguistically similar phrases;
linking a musical structure to the educational lesson, wherein the musical structure includes a metric level and a tempo consistent with the linguistically similar phrases; and
correlating a portion of the linguistically similar phrases of the educational lesson with a visual cue based on the musical structure.

14. A method for educational fluency and comprehension training according to claim 13, further comprising instructing a user to vocalize the linguistically similar phrases.

15. A method for educational fluency and comprehension training according to claim 13, wherein forming includes syntactically controlling a syllabication length of the linguistically similar phrases.

16. A method for educational fluency and comprehension training according to claim 13, wherein linking includes matching the metric level and the tempo of the musical structure to each linguistically similar phrase.

17. A method for educational fluency and comprehension training according to claim 13, wherein the musical structure includes a range of notes selected to imply an emotion consistent with the educational lesson.

18. A method for educational fluency and comprehension training according to claim 17, wherein the range of notes produce complementary harmonies.

19. A method for educational fluency and comprehension training according to claim 17, wherein the range of notes produce dissonant harmonies.

20. A method for educational fluency and comprehension training according to claim 13, wherein correlating includes contemporaneously highlighting the linguistically similar phrases as the visual cue with audibilization of words comprising the linguistically similar phrases.
